(19) United States
(12) Patent Application Publication
(10) Pub. No.: US 2006/0073335 A1
(43) Pub. Date: Apr. 6, 2006

(54) Conductive electrolessly plated powder and method for making same

(76) Inventors: Masaaki Oyamada, Tokyo (JP); Shinji Abe, Tokyo (JP); Akihiro Kawazoe, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 11/258,173

(22) Filed: Oct. 26, 2005

Related U.S. Application Data
(62) Division of application No. 10/820,025, filed on Apr. 8, 2004.

(30) Foreign Application Priority Data
Oct. 10, 2002 (JP) 2002-297901

(51) Int. Cl. B32B 5/16; B32B 15/02

(52) U.S. Cl. 428/403; 428/404

(57) ABSTRACT

A conductive electroless plated powder includes core particles and a nickel film formed by an electroless plating process on the surface of each core particle, wherein crystal grain boundaries are not recognized in the cross section in the direction of the thickness of the nickel film when observed with a scanning electron microscope at a magnification of up to 100,000. A method for making such a conductive electroless plated powder is also disclosed.

### CROSS REFERENCE TO RELATED APPLICATION

This application is a divisional application of U.S. patent application Ser. No. 10/820,025 filed on Apr. 8, 2004, currently pending. This application is incorporated herein by reference.

### BACKGROUND OF THE INVENTION 1. Field of the Invention

The present invention relates to a conductive electroless plated powder and a method for making the same. More particularly, the present invention relates to a conductive electroless plated powder including core particles and a nickel film provided on each core particle, the nickel film having improved adhesion with the core particle.

2. Description of the Related Art

The present inventors have suggested a process for electroless plating plastic core particles, which includes the steps of allowing the plastic core particles to support noble metal ions using a surface treating agent capable of capturing noble metal ions, and immersing the plastic core particles in a plating solution to perform electroless plating (refer to Japanese Unexamined Patent Application Publication No. 61-64882). This is a so-called “initial make-up of plating bath” process, and the plating solution contains metallic salts, a reducing agent, a complexing agent, a buffering agent, a stabilizer, etc. In this process, adhesion between the plating film and the core particle can be advantageously improved. In order to further improve adhesion, the present inventors have also suggested a process in which the electroless plating process described above is further improved (refer to Japanese Unexamined Patent Application Publication No. 1-242782).

However, requirements for various properties of electroless plated powders are becoming stricter, and requirements for adhesion between plating films and core particles are also becoming strict.

### SUMMARY OF THE INVENTION

It is an object of the present invention to provide a conductive electroless plated powder in which adhesion between plating films and core particles is improved, and a method for making the same.

As a result of thorough research, the present inventors have found that, by forming a plating film in which crystal grain boundaries are not recognized, it is possible to form a plated powder having superior adhesion between the plating films and the core particles compared to the plating powder disclosed in either Japanese Unexamined Patent Application Publication No. 61-64882 or 1-242782.

In one aspect of the present invention, a conductive electroless plated powder includes core particles and a nickel film formed by an electroless plating process on the surface of each core particle, wherein crystal grain boundaries are not recognized in the cross section in the direction of the thickness of the nickel film when observed with a scanning electron microscope at a magnification of up to 100,000.

In another aspect of the present invention, a method for making the conductive electroless plated powder described above includes the steps of allowing the core particles which have a noble metal ion-capturing ability to capture noble metal ions, and reducing the noble metal ions so that the surfaces of the core particles support the noble metal; dispersing the core particles in an aqueous medium containing a completing agent composed of an organic carboxylic acid or a salt thereof to prepare an aqueous suspension; and adding a nickel ion-containing solution containing the same complexing agent and a reducing agent-containing solution individually and simultaneously to the aqueous suspension to perform electroless plating.

### BRIEF DESCRIPTION OF THE DRAWINGS

FIG. 1 is a scanning electron microscope photograph showing an example of a cross section of a plating film of a conductive electroless plated powder of the present invention.

FIG. 2 is a scanning electron microscope photograph showing an example of a cross section of a plating film of a conventional conductive electroless plated powder.

### DESCRIPTION OF THE PREFERRED EMBODIMENTS

The preferred embodiments of the present invention will be described with reference to drawings. In a conductive electroless plated powder (hereinafter also referred to as “plated powder”) of the present invention, the surface of a core particle is coated with a nickel film by an electroless plating process.

In the nickel film formed on the surface of the core particle, crystal grain boundaries are not recognized in the cross section in the direction of the thickness of the nickel film, i.e., perpendicularly to the surface of the core particle. Crystal grain boundaries being not recognized means that crystal grain boundaries are not present or that even if crystal grain boundaries are present, the crystal grain boundaries are too minute to be recognized. Whether or not crystal grain boundaries are not recognized in the cross section in the direction of the thickness of the nickel film can be visually observed with a scanning electron microscope (hereinafter also referred to as “SEM”). Specifically, crystal grain boundaries being not recognized is defined as a state in which crystal grain boundaries are not recognized when the cross section in the thickness direction of the nickel film is observed with a SEM at a magnification of up to 100,000.

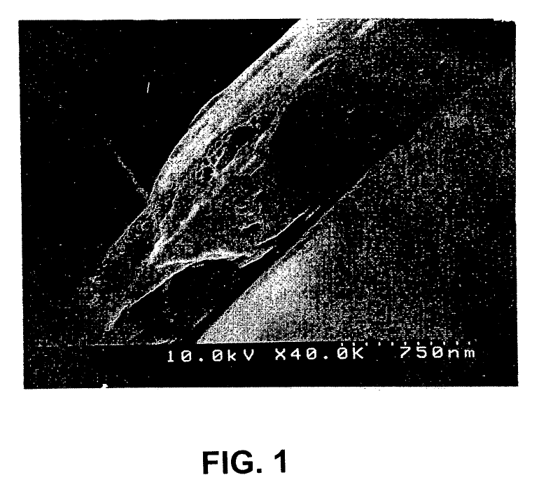

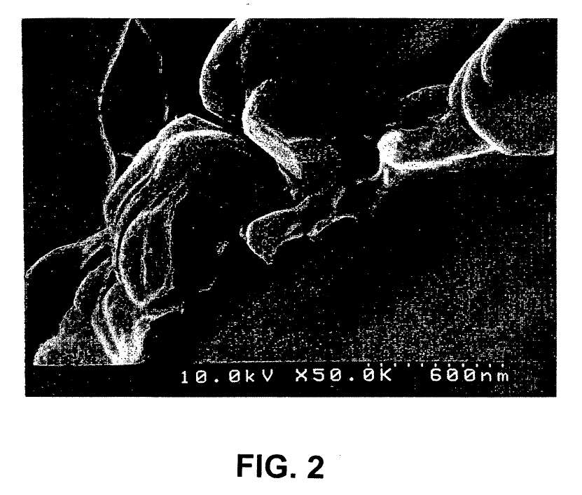

FIG. 1 is a SEM photograph showing an example of a plated powder of the present invention. The magnification is 40,000. As is clear from FIG. 1, crystal grain boundaries are not observed in the cross section in the direction of the thickness of the nickel film of the plated powder. On the other hand, in a SEM photograph (magnification: 50,000) showing a conventional electroless nickel plated powder shown in FIG. 2, nodular crystal grain boundaries are observed in the cross section in the direction of the thickness of the nickel film.

As is obvious from FIG. 1, the nickel film of the plated powder of the present invention is dense, homogeneous, and continuous. On the other hand, in the nickel film of the conventional plated powder shown in FIG. 2, crystal grains are rough and heterogeneous. As will be evident from the examples described below, the present inventors have found that, in the nickel film in which crystal grain boundaries are not recognized as in FIG. 1, adhesion between the nickel film and the surface of the core particle is remarkably high. Although the reason for this is not clear, since crystal grains are not present in the nickel film or crystal grains are extremely minute even if they are present, the film is believed to become dense and homogeneous, resulting in an increase in adhesion between the nickel film and the surface of the core particle.

In order to observe the cross section of the nickel film of the plated powder with a SEM, for example, 50 parts by weight of the plated powder, 100 parts by weight of Epikote 815 (manufactured by Japan Epoxy Resins Co., Ltd.), 5 parts of weight of Epikure (manufactured by Japan Epoxy Resins Co., Ltd.) are kneaded, and the mixture is formed into a sample of 10 mm×10 mm×2 mm by curing for 10 minutes with a dryer at 110° C. The resultant sample is bent and ruptured, and the rupture cross section of the plating film is observed with a SEM.

As a result of X-ray diffraction analysis by the present inventors, it has been found that the nickel film of the plated powder of the present invention is not necessarily entirely amorphous and is partially crystalline, and that the nickel film is generally in the mixed state of being crystalline and being amorphous. However, the crystal form of the nickel film is not critical in the present invention. Desired adhesion is achieved as long as crystal grain boundaries are not recognized in the cross section in the direction of the thickness regardless of whether the nickel film is crystalline or amorphous.

The thickness of the nickel film greatly affects adhesion characteristics. If the film thickness is too large, the nickel film is likely to peel off. If the film thickness is too small, it is not possible to achieve desired conductivity. From these viewpoints, the thickness of the nickel film is preferably in the range of 0.005 to 10 μm and more preferably about 0.01 to 2 μm. For example, the thickness of the nickel film may be measured by SEM observation or may be calculated based on the amount of nickel ions added or chemical analysis.

Additionally, the nickel film may be composed of an alloy of nickel and another element depending on the type of the reducing agent used when the nickel film is formed by electroless plating. For example, when sodium hypophosphite is used as the reducing agent, the resultant nickel film is composed of a nickel-phosphorus alloy. In the present invention, such a nickel alloy film is also broadly interpreted as a nickel film.

In the plated powder of the present invention, the nickel film is formed on the surface of the core particle. In order to further improve the conductivity of the plated powder, a thin gold plating layer may be formed on the nickel film of the plated powder. The gold plating layer is formed by electroless plating as is the nickel film. The thickness of the gold plating layer is usually about 0.001 to 0.5 μm. The thickness of the gold plating layer may be calculated based on the amount of gold ions added or chemical analysis.

The core particle on which the nickel film is formed is not particularly limited and may be composed of an organic substance or inorganic substance. In view of the electroless plating process which will be described below, the core particle is preferably dispersible in water. Accordingly, preferably, the core particle is substantially insoluble in water, and more preferably, insoluble in or unchangeable by acid or alkali. Being dispersible in water means that it is possible to form a suspension in which the core particle is substantially dispersed in water by ordinary dispersion means, such as stirring, so that the nickel film can be deposited on the surface of the core particle.

The shape of the core particle is not particularly limited. Although the core particle is generally particulate, the core particle may be of another shape, such as fibrous, hollow, plate-like, or acicular. Alternatively, the core particle may have no regular form. The size of the core particle is appropriately selected depending on the specific applications of the plated powder of the present invention. For example, when the plated powder of the present invention is used as an electrically conductive material for electronic circuit connection, the core particle is preferably spherical with an average particle size of about 0.5 to 1,000 μm.

Specific examples of materials for the core particle include inorganic substances, such as metals (including alloys), glass, ceramics, silica, carbon, oxides of metals or nonmetals (including hydrates), metal silicates including aluminosilicate, metal carbides, metal nitrides, metal carbonates, metal sulfates, metal phosphates, metal sulfides, metal acid salts, metal halides, and carbon; and organic substances, such as natural fibers, natural resins, thermoplastic resins, e.g., polyethylene, polypropylene, poly(vinyl chloride), polystyrene, polybutene, polyamides, polyacrylate esters, polyacrylonitrile, polyacetals, ionomers, and polyesters, alkyd resins, phenolic resins, urea resins, benzoguanamine resins, melamine resins, xylene resins, silicone resins, epoxy resins, and diallyl phthalate resins. These may be used alone or in combination of two or more.

Preferably, the surface of the core particle has a noble metal ion-capturing ability or is subjected to surface treatment so as to have a noble metal ion-capturing ability. The noble metal ions are preferably palladium ions or silver ions. Having a noble metal ion-capturing ability means having an ability to capture noble metal ions as chelates or salts. For example, when amino groups, imino groups, amide groups, imide groups, cyano groups, hydroxyl groups, nitrile groups, carboxyl groups, or the like are present on the surface of the core particle, the surface of the core particle has a noble metal ion-capturing ability. When the core particle is subjected to surface treatment so as to have a noble metal ion-capturing ability, for example, a method disclosed in Japanese Unexamined Patent Application Publication No. 61-64882 may be used.

Next, a preferred method for making the plated powder of the present invention will be described below. The method for making the plated powder mainly includes a catalyzation step (1), an initial thin film formation step (2), and an electroless plating step (3). In the catalyzation step (1), the core particles which have a noble metal ion-capturing ability or to which a noble metal ion-capturing ability is imparted by surface treatment are allowed to capture noble metal ions, and then the noble metal ions are reduced so that the surfaces of the core particles support the noble metal. In the initial thin film formation step (2), the core particles supporting the noble metal are dispersed in an initial thin film-forming solution containing nickel ions, a reducing agent, and a complexing agent composed of an organic carboxylic acid or a salt thereof so that nickel ions are reduced to form initial thin nickel films on the surfaces of the core particles. In the electroless plating step (3), a nickel ion-containing solution containing the same complexing agent and a reducing agent-containing solution are individually and simultaneously added to an aqueous suspension containing the core particles provided with the nickel initial thin films and the complexing agent to carry out electroless plating. The individual steps will be described in detail below.

(1) Catalyzation Step

When the core particle itself has a noble metal ion-capturing ability, catalyzation is performed directly. If the core particle does not have a noble metal ion-capturing ability, surface treatment is performed. In the surface treatment, core particles are added to water or an organic solvent in which a surface treatment agent is dissolved, and the mixture is stirred thoroughly to enable dispersion. The core particles are then separated and dried. The amount of the surface treatment agent used depends on the type of the core particle, and by adjusting the amount in the range of 0.3 to 100 mg per 1 m² of the surface area of the core particles, a uniform surface treatment effect is achieved.

Next, the core particles are dispersed in a weakly acidic aqueous solution of a noble metal salt, such as palladium chloride or silver nitrate. Thereby, the noble metal ions are captured by the surfaces of the core particles. The sufficient concentration of the noble metal salt is in the range of 1×10⁻⁷ to 1×10⁻² moles per 1 m² of the surface area of the core particles. The core particles having the captured noble metal ions are separated from the system and washed with water. Subsequently, the core particles are suspended in water, and a reducing agent is added to the suspension to reduce the noble metal ions. Thereby, the surfaces of the core particles support the noble metal. Examples of reducing agents which may be used include sodium hypophosphite, sodium borohydride, potassium borohydride, dimethylamine borane, hydrazine, and formalin.

Before the surfaces of the core particle capture noble metal ions, sensitization may be performed in which tin ions are allowed to adsorb to the surfaces of the core particles. In order to allow tin ions to adsorb to the surfaces of the core particles, for example, the core particles which have been subjected to surface treatment are put in an aqueous solution of stannous chloride, and stirring is performed for a predetermined period of time.

(2) Initial Thin Film Formation Step

The initial thin film formation step is carried out to deposit nickel uniformly on the core particles and to smooth the surfaces of the core particles. In the initial thin film formation step, first, the core particles supporting the noble metal are dispersed in water thoroughly. A shear dispersing machine, such as a colloid mill or homogenizer, may be used for dispersion. When the core particles are dispersed, for example, a dispersing agent, such as a surfactant, may be used as necessary. The aqueous suspension thus prepared is mixed and dispersed in an initial thin film-forming solution containing nickel ions, a reducing agent, and a complexing agent composed of an organic carboxylic acid or a salt thereof. Thereby, the reduction of nickel ions is started, and nickel initial thin films are formed on the surfaces of the core particles. As described above, since the initial thin film formation step is carried out to deposit nickel uniformly on the core particles and to smooth the surfaces of the core particles, the resultant initial thin nickel films only require a small thickness which enables smoothing the surfaces of the core particles. From this viewpoint, the thickness of the initial thin film is preferably 0.001 to 2 μm and more preferably 0.005 to 1 μm. The thickness of the initial thin film can be calculated based on the amount of nickel ions added or chemical analysis. Additionally, the complexing agent is not consumed by the reduction of nickel ions.

In order to form the initial thin film with the thickness described above, the concentration of nickel ions in the initial thin film-forming solution is preferably 2.0×10⁻⁴ to 1.0 moles/l and more preferably 1.0×10⁻³ to 0.1 moles/l. As a nickel ion source, a water-soluble nickel salt, such as nickel sulfate or nickel chloride, is used. From the same viewpoint, the concentration of the reducing agent in the initial thin film-forming solution is preferably 4×10⁻⁴ to 2.0 moles/l and more preferably 2.0×10⁻³ to 0.2 moles/l. As the reducing agent, the same agents as those used for the reduction of noble metal ions described above may be used.

It is important to involve a complexing agent in the initial thin film-forming solution. By incorporating the complexing agent in the initial thin film-forming solution and by incorporating the complexing agent in the nickel ion-containing solution which will be described below, it is possible to easily form a nickel film in which crystal grain boundaries are not recognized. A complexing agent is a compound having a complex-forming action with metal ions used for plating. In the present invention, as the complexing agent, an organic carboxylic acid or a salt thereof is used. Examples include citric acid, hydroxyacetic acid, tartaric acid, malic acid, lactic acid, gluconic acid, or alkali metal salts or ammonium salts of these acids. These complexing agents may be used alone or in combination of two or more. Among these complexing agents, tartaric acid or a salt thereof is preferably used because it is possible to easily form a nickel film in which crystal grain boundaries are not recognized. The complexing agent concentration affects the formation of the nickel film in which crystal grain boundaries are not recognized. From this viewpoint and from the viewpoint of the solubility of the complexing agent, the amount of the complexing agent in the initial thin film-forming solution is preferably 0.005 to 6 moles/l and more preferably 0.01 to 3 moles/l.

In view of the fact that the initial thin film can be easily formed, the concentration of the core particles in the aqueous suspension is preferably 0.1 to 500 g/l and more preferably 0.5 to 300 g/l.

The aqueous suspension prepared by mixing the aqueous suspension containing the core particles and the initial thin film-forming solution is subjected to the electroless plating step which will be described below. In the aqueous suspension before being subjected to the electroless plating step, the ratio of the sum of the surface areas of the core particles contained in the aqueous suspension to the volume of the aqueous suspension, which is generally referred to as a load, is preferably 0.1 to 15 m²/l and more preferably 1 to 10 m²/l in view of the fact that it is possible to easily form the nickel film in which crystal grain boundaries are not recognized. If the load is too heavy, in the electroless plating step which will be described below, nickel ions are extremely reduced in the liquid phase, and a large amount of fine nickel particles is generated in the liquid phase and attached to the surfaces of the core particles, resulting in a difficulty in forming uniform nickel films.

(3) Electroless Plating Step

In the electroless plating step, three solutions are used, i.e., an aqueous suspension (a) containing the core particles provided with the initial thin films and the complexing agent, a nickel ion-containing solution (b), and a reducing agent-containing solution (c). The aqueous suspension obtained in the initial thin film formation step is used as the aqueous suspension (a).

Apart from the aqueous suspension (a), the nickel ion-containing solution (b) and the reducing agent-containing solution (c) are prepared. The nickel ion-containing solution is an aqueous solution of a water-soluble nickel salt, such as nickel sulfate or nickel chloride, which is a nickel source. The nickel ion concentration is preferably 0.1 to 1.2 moles/l and more preferably 0.5 to 1.0 moles/l in view of the fact that a nickel film in which crystal grain boundaries are not recognized can be easily formed.

It is important to incorporate the same complexing agent as that incorporated in the aqueous suspension in the nickel ion-containing solution. That is, it is important that the same completing agent is incorporated in both the aqueous suspension (a) and the nickel ion-containing solution (b). Consequently, it is possible to easily form a nickel film in which crystal grain boundaries are not recognized. Although the reason for this is not clear, by incorporating the completing agent in both the aqueous suspension (a) and the nickel ion-containing solution (b), the nickel ions are thought to be stabilized, thus preventing the nickel ions from rapidly being reduced.

The concentration of the completing agent in the nickel ion-containing solution (b) also affects the formation of the nickel film as in the concentration of the complexing agent in the aqueous suspension (a). From this viewpoint and from the viewpoint of the solubility of the complexing agent, the amount of the complexing agent in the nickel ion-containing solution is preferably 0.01 to 12 moles/l and more preferably 0.02 to 6 moles/l.

The reducing agent-containing solution (c) is generally an aqueous solution of a reducing agent. As the reducing agent, the same reducing agents as those used in the reduction of noble metal ions described above may be used. In particular, sodium hypophosphite is preferably used. Since the reducing agent concentration affects the reduced condition of nickel ions, the concentration is adjusted preferably in the range of 0.1 to 20 moles/l and more preferably in the range of 1 to 10 moles/l.

The two solutions, i.e., the nickel ion-containing solution (b) and the reducing agent-containing solution (c), are individually and simultaneously added to the aqueous suspension (a). Thereby, nickel ions are reduced, and nickel is deposited on the surface of the core particle to form a nickel film. The adding rates of the nickel ion-containing solution and the reducing agent-containing solution are effective in controlling the deposition rate of nickel. The deposition rate of nickel affects the formation of a nickel film in which crystal grain boundaries are not recognized. Therefore, by adjusting the adding rates of the two solutions, the deposition rate of nickel is controlled preferably at 1 to 10,000 nanometers/hour and more preferably at 5 to 300 nanometers/hour. The deposition rate of nickel can be calculated based on the adding rate of the nickel ion-containing solution.

While the two solutions are being added to the aqueous suspension, the concentration of the complexing agent in the aqueous suspension is not constant and changes due to the increase in the amount of the aqueous suspension because of the addition of the two solutions and due to the addition of the completing agent contained in the nickel ion-containing solution. As a result of investigation by the present inventors, it has been found that, also in consideration of the solubility of the completing agent, it is advantageous to maintain the concentration of the complexing agent in the aqueous suspension in the range of 0.005 to 6 moles/l and preferably in the range of 0.02 to 3 moles/l during the addition of the two solutions in this method. By maintaining the concentration of the complexing agent in the aqueous suspension during the addition of the two solutions within the range described above, it is possible to more easily form a nickel film in which crystal grain boundaries are not observed. In order to maintain the concentration of the complexing agent in the aqueous suspension within the range described above, the adding rates of the nickel ion-containing solution and the reducing agent-containing solution (the nickel deposition rate), the initial concentration of the completing agent in the aqueous suspension, or the concentration of the complexing agent in the nickel ion-containing solution may be adjusted. These values have been described above.

While the two solutions are being added to the aqueous suspension, the load described above is maintained preferably in the range of 0.1 to 15 m²/l and more preferably in the range of 1 to 10 m²/l. Thereby, it is possible to more easily form a nickel film in which nickel is uniformly deposited and crystal grain boundaries are not recognized. From the same reason, the load is preferably in the range described above when the addition of the two solutions is completed and the reduction of nickel ions is completed.

The plated powder in which the nickel films are formed on the surfaces of the core particles is formed as described above. In the nickel film of the plated powder, crystal grain boundaries are not recognized in the cross section in the direction of the thickness of the nickel film.

Although it depends on the type of the reducing agent used, during the reduction of nickel ions, the pH of the aqueous suspension is maintained preferably in the range of 3 to 13 and more preferably in the range of 4 to 11 in order to prevent water-insoluble precipitates of nickel from being generated. In order to adjust the pH, for example, a predetermined amount of a pH adjuster, such as sodium hydroxide, may be added in the reducing agent-containing solution.

The resultant plated powder is separated after being subjected to filtration and washing with water several times. Furthermore, as an additional step, a gold plating layer may be formed as the top layer on the nickel film. In order to form the gold plating layer, a known electroless plating method may be employed. For example, by adding an electroless plating solution which contains tetrasodium ethylenediaminetetraacetate, trisodium citrate, and gold potassium cyanide and in which the pH is adjusted by sodium hydroxide to an aqueous suspension of the plated powder, a gold plating layer is formed on the nickel film.

The plated powder thus produced is suitable for use in anisotropic conductive films (ACFs), heat seal connectors (HSCs), conductive materials for connecting electrodes of liquid crystal display panels to circuit boards of driving LSIs, etc.

The present invention is not limited to the embodiment described above. Instead of forming a nickel film in which crystal grain boundaries are not recognized on the surface of a core particle, for example, a nickel film in which crystal grain boundaries are not recognized may be formed on the surface another metal film provided on the surface of a core particle.

The method for making the plated powder of the present invention is not limited to the method described above. In the method described above, the catalyzation step (1), the initial thin film formation step (2), and the electroless plating step (3) are carried out. However, depending on the types of the core particle, the initial thin film formation step may be omitted. In such a case, the core particles prepared in the catalyzation step are dispersed in an aqueous medium containing a complexing agent composed of an organic carboxylic acid or a salt thereof to prepare an aqueous suspension, and the nickel ion-containing solution and the reducing agent-containing solution are added thereto.

### EXAMPLES

The present invention will be described in more detail based on the examples below. However, it is to be understood that the present invention is not limited thereto.

### Examples 1 to 4

(1) Catalyzation Step

Spherical silica with an average particle size of 12 μm and an absolute specific gravity of 2.23 was used as core particles. The spherical silica (40 g) was added to 400 ml of an aqueous conditioner solution (Cleaner Conditioner 231 manufactured by Shipley Corporation) while being stirred. The concentration of the aqueous conditioner solution was 40 ml/l. Stirring was continued for 30 minutes at a solution temperature of 60° C. under ultrasonic radiation to perform surface treatment and dispersion. The aqueous solution was filtered, and the core particles were subjected to repulping—washing with water (in the so called “repulping washing”, the core particles are re-slurried and washed with water) one time and formed into 200 ml of slurry. To the slurry was added 200 ml of an aqueous solution of stannous chloride. The concentration of the aqueous solution was 5×10⁻³ moles/l. Stirring was performed at normal temperature for 5 minutes to perform sensitization in which tin ions were allowed to adsorb to the surfaces of the core particles. The aqueous solution was then filtered and repulping—washing with water was performed one time. The core particles were formed into 400 ml of slurry and maintained at 60° C. While stirring the slurry under ultrasonic radiation, 2 ml of an aqueous palladium chloride solution (0.11 moles/l) was added to the slurry. Stirring was continued for another 5 minutes to perform activation in which palladium ions were captured by the surfaces of the core particles. The aqueous solution was then filtered, and the core particles were subjected to repulping—washing with hot water one time and formed into 200 ml of slurry. The slurry was stirred under ultrasonic radiation, and 20 ml of a mixed aqueous solution of dimethylamine borane (0.017 moles/l) and boric acid (0.16 moles/l) was added thereto. Stirring was performed at normal temperature for 2 minutes under ultrasonic radiation to reduce palladium ions.

(2) Initial Thin Film Formation Step

An aqueous suspension was prepared by adding 200 ml of the slurry obtained in step (1) to the initial thin film-forming solution (a) shown in Table 1 in each Example. The initial thin film-forming solution was heated to 75° C., and the solution volume was 1.8 liters. Immediately after the addition of the slurry, generation of hydrogen was observed and the start of initial thin film formation was confirmed. After one minute, 0.063 moles of sodium hypophosphite was added to the aqueous suspension, and stirring was continued for another 1 minute. The load of the aqueous suspension was 4.5 m²/l.

(3) Electroless Plating Step

Two solutions, i.e., the nickel ion-containing solution (b) and the reducing agent-containing solution (c) shown in Table 1, were added to the aqueous suspension prepared in the initial thin film formation step each at the adding rate shown in Table 1. The volume of each solution added was 870 ml. Immediately after the addition of the two solutions, generation of hydrogen was observed, and the start of plating reaction was confirmed. Until the addition of the two solutions was completed, the concentration of the organic carboxylic acid in the aqueous suspension was maintained at the value shown in Table 1. After the completion of the addition of the two solutions, stirring was continued while maintaining the temperature at 75° C. until bubbling of hydrogen was stopped. The load after the completion of the addition of the two solutions was 2.4 m²/l. The aqueous suspension was then filtered, and the filtrate was subjected to repulping—washing three times, followed by drying with a vacuum dryer at 110° C. A plated powder having nickel-phosphorus alloy plating films was thereby produced. The cross section of the plating film of the resultant plated powder was observed with a SEM at a magnification of 40,000. As in FIG. 1, crystal grain boundaries were not recognized in the cross section in the direction of the thickness of the film. The thickness of the plating film was 0.54 μm, which was calculated based on the amount of nickel ions added.

### Examples 5 to 8

An electroless plating solution for gold plating (1 liter) was prepared. The electroless plating solution contained 0.027 moles/l tetrasodium ethylenediaminetetraacetate, 0.038 moles/l trisodium citrate, and 0.01 moles/l gold potassium cyanide, and the pH of the electroless plating solution was adjusted to 6 by an aqueous sodium hydroxide solution. While stirring the electroless plating solution at a solution temperature of 60° C., 33 g of the plated powder produced in each of Examples 1 to 4 was added to the plating solution, and gold plating was performed for 20 minutes. The solution was filtered, and the filtrate was subjected to repulping—washing three times, followed by drying with a dryer at 110° C. A plated powder in which electroless gold plating layers were formed on the nickel films was thereby produced in each of Examples 5 to 8. The thickness of the gold plating layer was 0.025 μm, which was calculated based on the amount of gold ions added.

### Example 9

(1) Catalyzation Step

A spherical benzoguanamine-melamine-formalin resin (trade name: EPOSTAR manufactured by Nippon Shokubai Co., Ltd.) with an average particle size of 14 μm and an absolute specific gravity of 1.39 was used as core particles. The core particle (30 g) was formed into 400 ml of slurry, and the slurry was maintained at 60° C. While stirring the slurry under ultrasonic radiation, 2 ml of an aqueous palladium chloride solution (0.11 moles/l) was added to the slurry. Stirring was continued for another 5 minutes to perform activation in which palladium ions were captured by the surfaces of the core particles. The aqueous solution was then filtered, and the core particles were subjected to repulping—washing with hot water one time and formed into 200 ml of slurry. The slurry was stirred under ultrasonic radiation, and 20 ml of a mixed aqueous solution of dimethylamine borane (0.017 moles/l) and boric acid (0.16 moles/l) was added thereto. Stirring was performed at normal temperature for 2 minutes under ultrasonic radiation to reduce palladium ions.

(2) Initial Thin Film Formation Step

An aqueous suspension was prepared by adding 200 ml of the slurry obtained in step (1) to the initial thin film-forming solution (a) shown in Table 1. The initial thin film-forming solution was heated to 75° C., and the solution volume was 1.8 liters. Immediately after the addition of the slurry, generation of hydrogen was observed and the start of initial thin film formation was confirmed. After one minute, 0.042 moles of sodium hypophosphite was added to the aqueous suspension, and stirring was continued for another 1 minute. The load of the aqueous suspension was 4.6 m²/l.

(3) Electroless Plating Step

Two solutions, i.e., the nickel ion-containing solution (b) and the reducing agent-containing solution (c) shown in Table 1, were added to the aqueous suspension prepared in the initial thin film formation step at the adding rate shown in Table 1. The volume of each solution added was 224 ml. Immediately after the addition of the two solutions, generation of hydrogen was observed, and the start of plating reaction was confirmed. Until the addition of the two solutions was completed, the concentration of the organic carboxylic acid in the aqueous suspension was maintained at the value shown in Table 1. The load after the completion of the addition of the two solutions was 3.8 m²/l. After the completion of the addition of the two solutions, stirring was continued while maintaining the temperature at 75° C. until bubbling of hydrogen was stopped. The aqueous suspension was then filtered, and the filtrate was subjected to repulping—washing three times, followed by drying with a vacuum dryer at 110° C. A plated powder having nickel-phosphorus alloy plating films was thereby produced. The cross section of the plating film of the resultant plated powder was observed with a SEM at a magnification of 50,000. As in FIG. 1, crystal grain boundaries were not recognized in the cross section in the direction of the thickness of the film. The thickness of the plating film was 0.15 μm, which was calculated based on the amount of nickel ions added.

### Example 10

A plated powder in which electroless gold plating layers were formed on nickel films was produced as in Example 5 except that 18.1 g of the plated powder produced in Example 9 was used. The thickness of the gold plating layer was 0.025 μm, which was calculated based on the amount of gold ions added.

### Example 11

(1) Catalyzation Step

A spherical acrylic resin with an average particle size of 10 μm and an absolute specific gravity of 1.33 was used as core particles. The spherical acrylic resin (20 g) was formed into 200 ml of slurry. To the slurry was added 200 ml of an aqueous solution of stannous chloride. The concentration of the aqueous solution was 5×10⁻³ moles/l. Stirring was performed at normal temperature for 5 minutes to perform sensitization in which tin ions were allowed to adsorb to the surfaces of the core particles. The aqueous solution was then filtered and repulping—washing with water was performed one time. The core particles were formed into 400 ml of slurry and maintained at 60° C. While stirring the slurry under ultrasonic radiation, 2 ml of an aqueous palladium chloride solution (0.11 moles/l) was added to the slurry. Stirring was continued for another 5 minutes to perform activation in which palladium ions were captured by the surface of the core particle. The aqueous solution was then filtered, and the core particle was subjected to repulping—washing with hot water one time and formed into 200 ml of slurry. The slurry was stirred under ultrasonic radiation, and 20 ml of a mixed aqueous solution of dimethylamine borane (0.017 moles/l) and boric acid (0.16 moles/l) was added thereto. Stirring was performed at normal temperature for 2 minutes under ultrasonic radiation to reduce palladium ions.

(2) Initial Thin Film Formation Step

An aqueous suspension was prepared by adding 200 ml of the slurry obtained in step (1) to the initial thin film-forming solution (a) shown in Table 1. The initial thin film-forming solution was heated to 75° C., and the solution volume was 1.8 liters. Immediately after the addition of the slurry, generation of hydrogen was observed and the start of initial thin film formation was confirmed. After one minute, 0.042 moles of sodium hypophosphite was added to the aqueous suspension, and stirring was continued for another 1 minute. The load of the aqueous suspension was 4.5 m²/l.

(3) Electroless Plating Step

Two solutions, i.e., the nickel ion-containing solution (b) and the reducing agent-containing solution (c) shown in Table 1, were added to the aqueous suspension prepared in the initial thin film formation step at the adding rate shown in Table 1. The volume of each solution added was 220 ml. Immediately after the addition of the two solutions, generation of hydrogen was observed, and the start of plating reaction was confirmed. Until the addition of the two solutions was completed, the concentration of the organic carboxylic acid in the aqueous suspension was maintained at the value shown in Table 1. After the completion of the addition of the two solutions, stirring was continued while maintaining the temperature at 75° C. until bubbling of hydrogen was stopped. The aqueous suspension was then filtered, and the filtrate was subjected to repulping—washing three times, followed by drying with a vacuum dryer at 110° C. The load after the completion of the addition of the two solutions was 3.7 m²/l. A plated powder having nickel-phosphorus alloy plating films was thereby produced. The cross section of the plating film of the resultant plated powder was observed with a SEM at a magnification of 50,000. As in FIG. 1, crystal grain boundaries were not recognized in the cross section in the direction of the thickness of the film. The thickness of the plating film was 0.15 μm, which was calculated based on the amount of nickel ions added.

### Example 12

A plated powder in which electroless gold plating layers were formed on nickel films was produced as in Example 5 except that 13.8 g of the plated powder produced in Example 11 was used. The thickness of the gold plating layer was 0.025 μm, which was calculated based on the amount of gold ions added.

### Comparative Example 1

In Comparative Example 1, the initial make-up of plating bath process conventionally used in electroless plating was employed. Up to a catalyzation step, core particles were prepared as in Example 1. An electroless plating solution which contained 0.11 moles/l nickel sulfate, 0.24 moles/l sodium hypophosphite, 0.26 moles/l sodium malate, 0.18 moles/l sodium acetate, and 2×10⁻⁶ moles/l lead acetate and in which the pH was adjusted to 5 was used. The electroless plating solution (6 liters) was heated to 75° C. to make up a plating bath. The core particles subjected to the catalyzation step were placed in the bath and dispersed by mixing to start the reduction of nickel. During the reduction, the pH of the solution was maintained at 5 by adding a 5 moles/l aqueous sodium hydroxide solution with a pH automatic controller. When the reaction was stopped halfway, a 2 moles/l aqueous sodium hypophosphite solution was added little by little to continue the reaction. When the plating solution did not bubble even by the addition of the aqueous sodium hypophosphite solution, all the additions were stopped, and the plating solution was filtered. The filtrate was subjected to repulping—washing three times, followed by drying with a vacuum dryer at 110° C. A powder having nickel-phosphorus alloy plating films was thereby produced. The cross section of the plating film of the resultant plated powder was observed with a SEM at a magnification of 50,000. As in FIG. 2, nodular crystal grain boundaries were observed in the cross section in the direction of the thickness of the film. Since this plated powder was produced by the conventional electroless plating process, fine nickel decomposition products were mixed in the plated powder, and thus it was not possible to use the plated powder practically.

### Comparative Example 2

Core particles subjected to the catalyzation step as in Example 1 was formed into 200 ml of slurry. An aqueous suspension was prepared by adding the slurry to the initial thin film-forming solution (a) shown in Table 1 while stirring. The initial thin film-forming solution was heated to 75° C., and the solution volume was 1.8 liters. Immediately after the addition of the slurry, generation of hydrogen was observed and the start of initial thin film formation was confirmed. After one minute, 0.063 moles of sodium hypophosphite was added to the aqueous suspension, and stirring was continued for another 1 minute. Two solutions, i.e., the nickel ion-containing solution (b) and the reducing agent-containing solution (c) shown in Table 1, were added to the aqueous suspension at the adding rate shown in Table 1. The volume of each solution added was 870 ml. Immediately after the addition of the two solutions, generation of hydrogen was observed, and the start of plating reaction was confirmed. After the completion of the addition of the two solutions, stirring was continued while maintaining the temperature at 75° C. until bubbling of hydrogen was stopped. The aqueous suspension was then filtered, and the filtrate was subjected to repulping—washing three times, followed by drying with a vacuum dryer at 110° C. A plated powder having nickel-phosphorus alloy plating films was thereby produced. The cross section of the plating film of the resultant plated powder was observed with a SEM at a magnification of 50,000. As in FIG. 2, nodular crystal grain boundaries were observed in the cross section in the direction of the thickness of the film. The thickness of the plating film was 0.54 μm, which was calculated based on the amount of nickel ions added.

### Comparative Example 3

A plated powder in which electroless gold plating layers were formed on nickel films was produced as in Example 5 except that 33 g of the plated powder produced in Comparative Example 2 was used. The thickness of the gold plating layer was 0.025 μm, which was calculated based on the amount of gold ions added.

Performance Evaluation

With respect to the plated powders produced in Examples 1 to 12 and Comparative Examples 1 to 3, volume resistivity was measured by a method described below. Adhesion of the plating film was also evaluated. The results thereof are shown in Table 2.

Measurement of Volume Resistivity

In a resin cylinder with an inside diameter of 10 mm standing vertically was placed 1.0 g of the plated powder. Under a load of 10 kg, electrical resistance between the upper and lower electrodes was measured, and the volume resistivity was calculated.

Evaluation of Adhesion of Plating Film

Into a 100-ml mayonnaise bottle was placed 2.2 g of the plated powder and 90 g of zirconia beads with a diameter of 1 mm. Toluene (10 ml) was also added into the mayonnaise bottle using a whole pipette. In the mayonnaise bottle, stirring was performed with a stirrer (TREEE ONE MOTOR) for 10 minutes at 400 rpm. After stirring was completed, the plated powder was separated from the zirconia beads. The plated powder was observed with a SEM. The degree of peeling of the plating film was evaluated according to the following criteria:

◯ Peeling of plating film not observed

x Peeling of plating film observed

TABLE 1

TABLE 2

As is evident from the results shown in Table 2, with respect to the plated powder in each Example (plated powder of the present invention), the electrical resistance is satisfactorily low, and adhesion of the plating film is satisfactorily high. In contrast, with respect to the plated powder in each Comparative Example, although the electrical resistance is low, the plating film is easily peeled off.

As described above in detail, in accordance with the present invention, adhesion between the plating film and the core particle can be improved.

TABLE 1

| | (a) Initial thin | | (b) Nickel ion- | | (c) Reducing agent- | | | Complexing agent |
|---|---|---|---|---|---|---|---|---|
| | film-forming solution | | containing solution | | containing solution | | | concentration |
| | | mol/l | | mol/l | | mol/l | Adding rate | mol/l |
| Example 1 | Sodium tartrate | 0.087 | Sodium tartrate | 0.17 | Sodium hypophosphite | 2.57 | 7 | 0.087 |
| | Nickel sulfate | 0.013 | Nickel sulfate | 0.86 | Sodium hydroxide | 2.6 | | |
| | Sodium hypophosphite | 0.032 | | | | | | |
| Example 2 | DL-malic acid | 0.03 | DL-malic acid | 0.06 | Sodium hypophosphite | 2.57 | 7 | 0.03 |
| | Nickel sulfate | 0.013 | Nickel sulfate | 0.86 | Sodium hydroxide | 2.6 | | |
| | Sodium hypophosphite | 0.032 | | | | | | |
| Example 3 | Sodium tartrate | 0.24 | Sodium tartrate | 0.48 | Sodium hypophosphite | 2.57 | 7 | 0.24 |
| | Nickel sulfate | 0.013 | Nickel sulfate | 0.86 | Sodium hydroxide | 2.6 | | |
| | Sodium hypophosphite | 0.032 | | | | | | |
| Example 4 | Sodium tartrate | 0.087 | Sodium tartrate | 0.17 | Sodium hypophosphite | 2.57 | 20 | 0.087 |
| | Nickel sulfate | 0.013 | Nickel sulfate | 0.86 | Sodium hydroxide | 2.6 | | |
| | Sodium hypophosphite | 0.032 | | | | | | |
| Example 9 | Sodium tartrate | 0.087 | Sodium tartrate | 0.25 | Sodium hypophosphite | 2.57 | 3 | 0.087 |
| | Nickel sulfate | 0.0086 | Nickel sulfate | 0.86 | Sodium hydroxide | 2.6 | | |
| | Sodium hypophosphite | 0.021 | | | | | | 0.106 |
| Example 11 | Sodium tartrate | 0.087 | Sodium tartrate | 0.25 | Sodium hypophosphite | 2.57 | 3 | 0.087 |
| | Nickel sulfate | 0.0086 | Nickel sulfate | 0.86 | Sodium hydroxide | 2.6 | | |
| | Sodium hypophosphite | 0.021 | | | | | | 0.106 |
| Comparative Example [symbol] | Nickel sulfate | 0.013 | Nickel sulfate | 0.86 | Sodium hypophosphite | 2.57 | 7 | — |
| | Sodium hypophosphite | 0.032 | | | | | | |

TABLE 2

| | Volume resistivity | Adhesion of |
|---|---|---|
| | Ω · cm | plating film |
| Example 1 | 9.0 × 10⁻² | ◯ |
| Example 2 | 9.1 × 10⁻² | ◯ |
| Example 3 | 8.9 × 10⁻² | ◯ |
| Example 4 | 9.5 × 10⁻² | ◯ |
| Example 5 | 2.3 × 10⁻³ | ◯ |
| Example 6 | 2.7 × 10⁻³ | ◯ |
| Example 7 | 2.5 × 10⁻³ | ◯ |
| Example 8 | 2.8 × 10⁻³ | ◯ |
| Example 9 | 9.0 × 10⁻² | ◯ |
| Example 10 | 2.0 × 10⁻³ | ◯ |
| Example 11 | 8.8 × 10⁻² | ◯ |
| Example 12 | 2.3 × 10⁻³ | ◯ |
| Comparative Example | Unmeasurable* | X |
| Comparative Example | 9.6 × 10⁻³ | X |
| Comparative Example | 3.0 × 10⁻³ | X |

*Since fine nickel decomposition products were mixed in the plated powder, it was not possible to use the plated powder practically.

What is claimed is:

1. A conductive electroless plated powder comprising:
core particles; and
a nickel film formed by an electroless plating process on a surface of each core particle,
wherein grainless boundaries are recognized in cross section in a direction of a thickness of the nickel film when observed with a scanning electron microscope at a magnification of up to 100,000.

2. The conductive electroless plated powder according to claim 1, further comprising an electroless gold plating film disposed on the nickel film.

3. A conductive electroless plated powder comprising:
core particles;
a nickel film formed by an electroless plating process on a surface of each core particle; and
an electroless gold plating film deposited on the nickel film, wherein a thickness of the electroless gold plating film is between 0.001 to 0.5 μm;
wherein grainless boundaries in the nickel film are recognized in the cross section in a direction of a thickness of the nickel film when observed with a scanning electron microscope at a magnification of up to 100,000.

4. The conductive electroless plated powder according to claim 3, wherein the core particles include inorganic substances and organic substances.

5. The conductive electroless plated powder according to claim 4, wherein the inorganic substances include at least one of silica and carbon.

6. The conductive electroless plated powder according to claim 4, wherein the organic substances include benzoguanamine resins.
